(19) United States
(12) Patent Application Publication
(10) Pub. No.: US 2010/0047554 A1
(43) Pub. Date: Feb. 25, 2010

(54) METHOD AND APPARATUS FOR MODIFYING SURFACE LAYER OF GLASS AND GLASS PRODUCT HAVING MODIFIED SURFACE LAYER

(75) Inventors: Markku Rajala, Vantaa (FI); Tommi Vainio, Soderkulla (FI); Sampo Ahonen, Espoo (FI); Joe Pimenoff, Helsinki (FI); Anssi Hovinen, Espoo (FI); Kai Asikkala, Helsinki (FI)

Correspondence Address: OLIFF & BERRIDGE, PLC, P.O. BOX 320850, ALEXANDRIA, VA, 22320-4850, US

(73) Assignee: BENEQ OY, Vantaa (FI)

(21) Appl. No.: 12/514,650

(22) PCT Filed: Nov. 16, 2007
(86) PCT No.: PCT/FI07/50619

§ 371 Date: May 13, 2009

(30) Foreign Application Priority Data
Nov. 17, 2006 (FI) 20061014

(51) Int. Cl. B32B 5/16; B05D 1/12; B05B 7/00

(52) U.S. Cl. 428/323; 427/180; 118/308

(57) ABSTRACT

The invention relates to a method of modifying a surface of a glass product. The method comprises conveying particles to the surface of the glass, a material contained in the particles being at least partly dissolved and diffused in the glass. The method comprises a step of heating the surface of the glass. The invention further relates to an apparatus for modifying a surface of a hot glass product. The invention still further relates to glass products wherein the content of an element which provides the glass with a functionality decreases steplessly upon proceeding from the surface of the glass deeper into the glass.

### FIELD OF THE INVENTION

The invention relates to a method of modifying a surface layer of glass according to the preamble of claim 1, and particularly to a method of modifying a surface layer of glass/a glass product, comprising conveying particles having a diameter of less than 1 micrometre to a surface of the glass, a material contained in the particles being at least partly dissolved and diffused in the glass. The present invention further relates to a glass product according to claim 13, and particularly to a glass product wherein a surface layer of the glass product is provided with a functionality by at least one additional material. The invention still further relates to an apparatus according to the preamble of claim 19, and particularly to an apparatus for modifying a surface layer of glass/a glass product, the apparatus comprising liquid flame spraying means for forming a spraying flame and means for conveying a sprayable material into the spraying flame, whereby the flame enables the sprayable material to be sprayed to a surface of the glass, the sprayable material forming in the flame particles having a diameter of less than 1 micrometre.

### DESCRIPTION OF THE PRIOR ART

The surface of a glass product plays an important role as far as the properties, such as the refractive index, scratch resistance and chemical resistance, of the product are concerned. A coating may be deposited on the surface of the glass product to improve the properties of the product. A separate coating may be deposited e.g. by using a technique called Chemical Vapour Deposition or CVD, or sputtering. However, a problem arises with adhesion of such a separate coating to the glass. Hence, modifying the surface of glass so as to provide the surface with desired properties generally gives a longer lasting solution than coatings.

It is known to modify the surface of glass in connection with surface colouring of glass. It is a technique which is hundreds of years old and based on ion exchange on the surface of glass. The method is widely used when glass is stained red or yellow using silver or copper. Typically, a copper or silver salt is mixed with a suitable medium and water is added to the mixture, resulting in a slurry having a suitable viscosity. This slurry is then spread onto the surface of the glass to be stained, and the piece of glass is heated typically to a temperature of a couple of hundreds of degrees, at which the ion exchange takes place and the glass becomes stained. Next, dry slurry is removed from the surface of the glass by washing and brushing. The method is not as such suitable for industrial production.

U.S. Pat. No. 1,977,625 discloses modified surface colouring of glass, which is based on spraying a solution containing both a salt of the colouring metal (silver nitrate in the example of the patent) and a reducing agent, such as sugar, glycerine or arabic gum, to a hot (approximately 600° C.) surface of the glass. The solution also contains a flux by which the melting point of the surface of the glass drops and the colouring ions penetrate into the glass. Such a flux may be e.g. a compound of lead and boron. The use of flux, however, generally causes a deterioration in the chemical and/or mechanical resistance of the surface of the glass; therefore, the method is not generally usable.

U.S. Pat. No. 2,428,600 discloses a method for producing surface-coloured glass, wherein glass containing alkali metals is brought into contact with a volatile copper halide, whereby ions of an alkali metal contained in a surface layer of the glass are exchanged for copper ions, whereafter the glass is brought into contact with hydrogen gas such that hydrogen-induced reduction of copper imparts colour to the surface of the glass. A reverse method of manufacture of the same—glass being first treated with hydrogen and then brought into contact with a copper halide vapour—is disclosed in U.S. Pat. No. 2,498,003.

U.S. Pat. No. 3,967,040 discloses a method for surface-colouring glass, in which method a reducing metal (preferably tin) adhered to the surface of the glass during a float process or otherwise attached thereto acts as a reducing agent so that upon surface-colouring the glass by means of a salt containing silver, a characteristic colour is produced. A salt of a colour metal in contact with the glass acts as a colouring agent.

U.S. Pat. No. 5,837,025 discloses a method of colouring glass by means of nanoscale glass particles. According to the method, glass-like coloured glass particles are produced which are introduced into the surface of the glass to be coloured and sintered into a transparent glass at a temperature of less than 900° C. Thus, the method does not modify the surface of the glass but provides it with a separate coating.

In Finnish Patent F198832, Method and device for spraying a material, a sprayable material is conveyed into a flame in a liquid form and converted into a droplet form with the aid of gas, essentially in the region of the flame. This enables very small particles, which are of the order of magnitude of nanometers, to be produced in a rapid, advantageous and single-stage manner.

Finnish Patent FI114548, Method of dyeing a material, describes a method of colouring glass by means of colloidal particles. In the method according to the patent, a flame spraying method is used for introducing colloidal particles into the material to be dyed. In the method, other components, such as a glass-forming liquid or gaseous material, which assist in the formation of colloidal particles of a correct size in the material, may also be added to the flame if desired.

A problem with the prior art is that it does not enable a controlled distribution of a nanoscale material in the material to be coated or doped, or in the surface or surface layer thereof Hence, the desired properties of the surface or the surface layer cannot be produced with a desired accuracy, and therefore the properties of the coated or doped product are not as desired in terms of quality, either.

Clearly, a need exists for a method and apparatus for enabling modification of a surface or a surface layer of a glass product to be carried out while manufacturing the glass product and a steplessly changing surface to be provided.

### SUMMARY OF THE INVENTION

An object of the present invention is to provide a method, an apparatus, and a product enabling the aforementioned problems to be solved.

The objects of the method according to the present invention are achieved by a method according to the characterizing part of claim 1, which is characterized by the dynamic viscosity of the glass changing as a function of the depth of the glass, the dynamic viscosity of the glass being at its lowest on the surface of the glass, whereby the diffusion and dissolution of the material contained in the particles into the glass decrease steplessly upon proceeding from the surface of the glass deeper into the glass. The object of the invention is further achieved by a glass product according to the characterizing part of claim 13, which is characterized in that the content of at least one additional material in the glass decreases steplessly upon proceeding from the surface of the glass deeper into the glass. The object of the present invention is further achieved by an apparatus according to the characterizing part of claim 19, which is characterized in that the apparatus is arranged to heat the glass (101) such that the dynamic viscosity of the glass changes as a function of the depth of the glass, the dynamic viscosity of the glass being at its lowest on the surface of the glass, whereby diffusion and dissolution of the material contained in the particles into the glass decrease steplessly upon proceeding from the surface of the glass deeper into the glass.

The object of the invention is achieved by a method comprising heating a surface layer of glass to be coated to a temperature at which the viscosity of the surface or the surface layer is substantially lower than the viscosity of the rest of the glass to be coated. Preferably, the surface layer of the glass may be heated by using a gas burner directed at the surface of the glass. In order to prevent the glass from breaking due to such heating, typically, the temperature of the glass being heated is to be higher than the annealing point of the glass, wherein the 10-base logarithm of the dynamic viscosity of the glass (in poise) is approximately 13.4. The annealing point of glass is 480 to 550° C. for soda glass, 530 to 600° C. for borosilicate glass, 700 to 800° C. for aluminium silicate glass, and 110 to 1200° C. for quartz glass, for example. For soda glass, for instance, within the area between the annealing point and the softening point of the glass (at which the 10-base logarithm of the dynamic viscosity is 7.6) the viscosity of glass decreases approximately by the order of 6 when the temperature rises 200° C. (N. P. Bansal and R. H. Doremus, Handbook of Glass Properties (1986), Academic Press, Inc., Orlando, p. 14 to 15 and 223 to 226).

Particles having a diameter of less than one micrometre, typically particles whose diameter is less than 300 nanometres, and most preferably particles whose diameter is less than 100 nm, are conveyed to a heated surface layer. A diameter herein refers to a diameter by which the number distribution of the particles obtains its maximum value. An advantage of a smaller diameter is a larger specific surface area of the material, in which case the material is more easily dissolved in the glass from the particles. The particles may be introduced into the surface of the glass e.g. by means of Brownian motion taking place in a gaseous state, diffusion, gravitation, impaction, thermopheresis, electric forces, magnetic forces, gas movements or corresponding forces. In the surface layer of the glass, the particles are made to move by various forces, particles having a diameter of less than 100 nm mainly by the Brownian motion. The magnitude and speed of the movement is substantially dependent on the viscosity of the glass. From the particles, a material dissolves and diffuses in to the glass which modifies the surface layer of the glass. When the temperature of the glass drops below the annealing point of the glass, the modified surface structure in the glass is locked, thus providing the glass with a stepless surface structure.

The present invention enables the Brownian motion to be utilized in coating of glass or in doping a surface layer thereof such that it enables a nanoscale material to be distributed in a controlled manner in a material to be coated, particularly in a surface layer thereof, and, further, the material is at least partly diffused and dissolved in the material to be coated. The method according to the invention enables the Brownian motion of the nanoscale material to be controlled by adjusting the viscosity of a liquid layer of the material to be coated. When the viscosity changes steplessly, the structure of a diffusion coating to be formed can also be made to change steplessly. This enables products with excellent properties and quality to be produced such that their properties can be accurately made as desired.

### BRIEF DESCRIPTION OF THE DRAWINGS

FIG. 1 illustrates behaviour of nanoparticles when a surface of glass is modified by a method according to the invention.

FIG. 2 shows a surface of glass modified by the method according to the invention so as to gradiently change a refractive index of the glass.

In the following, the invention will be described in more detail with reference to the drawings.

### DETAILED DESCRIPTION OF THE INVENTION

In the method according to the invention, particles having a diameter of less than 1 micrometre are conveyed to a surface of glass, a material contained in the particles being at least partly dissolved and diffused in the glass. The method comprises a step of heating the surface of the glass such that the dynamic viscosity of the glass changes as a function of the depth of the glass, being at its lowest on the surface of the glass. The diffusion and dissolution of the material contained in the particles into the glass decrease steplessly upon proceeding from the surface of the glass deeper into the glass. The change in the dynamic viscosity of the glass may be further enhanced such that particles to be conveyed to the surface of the glass comprise a material which lowers the dynamic viscosity of the glass.

Furthermore, the invention relates to an apparatus for modifying a surface or a surface layer of a hot glass or glass product. The apparatus is provided with means for conveying a combustion gas such that the combustion gas generates a flame. The apparatus is further provided with means for conveying a sprayable material into the flame, whereby the flame enables the sprayable material to be sprayed to a desired destination. In the flame, the sprayable material forms particles having a diameter of less than 1 micrometre. An essential point for the invention is that the apparatus is provided with means for conveying a flame to the surface of a glass product such that the flame heats up the surface of the glass product.

The invention further relates to glass products wherein the content of aluminium, silicon, strontium, titanium, or a glass-colouring metal or another substance, element or metal decreases steplessly upon proceeding from the surface of glass deeper into the glass.

Analysis of a surface or a surface layer of glass products is a relatively complex process, and different analyzing methods may give results slightly differing from one another. Hence, in the present context, glass is to be analyzed such that the content of a material in the glass is determined as an average value from layers having a thickness of one micrometre, proceeding from the surface of the glass downwards. Thus, in a product manufactured by means of the method according to the invention wherein material X dissolves in the glass from particles, the content of material X is at its highest in the outermost layer of the glass, which is 1 micrometre thick, decreasing upon proceeding deeper into the glass. In reality, the content decreases steplessly, although, as will be appreciated by those skilled in the art, the particular method of measurement does enable steps owing to the integrating nature of the measurement to be detected in the content. Typically, upon proceeding from the surface of the glass deeper into the glass, the content of material X decreases to a content level for basic glass over a distance of less than 100 micrometres, typically over a distance of less than 10 micrometres, and in some cases over a distance of less than 2 micrometres.

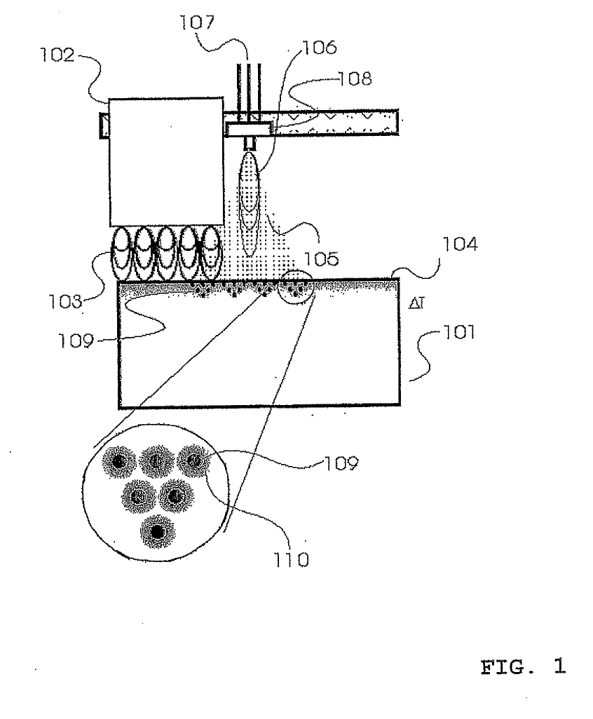

FIG. 1 shows a method of modifying a surface of glass according to the invention. The method enables the surface of glass to be modified substantially faster than the prior art methods. This is preferably particularly when combining the method according to the invention with a glass production process, such as a flat glass production process (float process), packaging glass production process or a glass casting process.

The surface of a glass product 101 is heated by a gas burner 102, which directs a convectively heating flow 103 to the surface of the product 101. Consequently, the glass product 101 is provided with a thermal gradient AT, on account of which the surface of the glass product 101 is provided with a layer 104 having a changing viscosity. Fine particles 105 whose diameter is preferably less than 1 micrometre, more preferably less than 300 nanometres, and most preferably less than 100 nanometres, are conveyed to the layer 104. The fine particles 105 are produced e.g. by a spraying method disclosed in Finnish Patent FI98832 by utilizing a liquid flame spraying apparatus 108 wherein fine particles are produced from liquid and gaseous raw materials 107 by means of a flame 106. The fine particles 105 penetrate into the surface layer 104 of the glass product 101 having a changing viscosity and move therein due to the influence of the Brownian motion, forming a layer consisting of fine particles 109. From the fine particles 109 of the particular layer, a material 110 dissolves and diffuses in the layer 104 of the glass product 101 to be modified. Upon cooling down, the layer 104 solidifies, thereby providing the surface of the glass product with a steplessly changing layer. In a preferred case, the maximum value of number distribution of the diameter of the particles conveyed to the surface of the glass is provided by particles of a size of less than 300 nm, and most preferably less than 100 nm. The particles may comprise only one substance or, alternatively, they may be multicomponent particles which comprise a plurality of substances.

For the Brownian motion (provided that the particles are spherical and much larger than molecules of a medium), the following equation applies

$${( \overline{Δ x} )}^{2} = \frac{RT}{N} \cdot \frac{t}{3 πη r} \qquad ( 1 )$$

wherein ( Δ̅x̅)² is the average movement caused by the Brownian motion of a particle in the direction of horizontal x-axis in time t, r is the radius of the particle, R a common gas constant, N Avogadro constant, T the absolute temperature of the medium, and η the viscosity of the medium (E. Tommila, Fysikaalinen kemia, 4^{th} edition (1969), Kustannusosakeyhtiö Otava, Helsinki, p. 493).

It is preferable to heat the surface of the glass product 101 convectively, because convective heat transfer mainly heats the surface layer 104 of the glass product 101, thus providing a glass layer with a steplessly changing viscosity. However, it is obvious to those skilled in the art that the surface of the glass product may also be heated using thermal radiation. Most preferably, the surface of the product is heated by gas burners arranged substantially perpendicularly to the surface, most effectively by using hydrogen gas as a fuel and oxygen as an oxidizing gas.

In principle, the surface may also be heated by a liquid flame spraying apparatus 108, but, particularly when modifying the surface of a moving, hot glass web while producing the glass web, the power of the liquid flame spraying apparatus 108 is typically not high enough to heat the surface of the glass product 101 sufficiently. For instance, in a float process, which is generally used in the manufacture of flat glass, a glass web having a width of 2 to 4 metres moves at a speed of 5 m/min to 20 m/min. Typically, a hydrogen gas flow of approximately 300 l/min per metre of the width of the web is used in the liquid flame spraying apparatus 108. Burning such a hydrogen gas flow produces a thermal power of approximately 55 kW. However, the thermal power is almost entirely directed at heating the gases, since the liquid flame spraying apparatus 108 located at a relatively long distance (100 to 200 mm) from the surface of the glass does not provide the surface of the glass with any significant convective heating. Also, the width of the flame parallel with the direction of movement of the web of the liquid flame spraying apparatus 108 is rather small, typically approximately 50 mm. In such a case, the glass spends only 0.1 to 0.6 seconds under the flame of the liquid flame spraying apparatus 108, which is not long enough to heat the surface of the glass sufficiently. Thus, a more preferable way to heat the glass is to arrange a second gas burner with a wide flame immediately before the liquid flame spraying apparatus 108 so as to enable the distance between this burner and the surface of the glass to be adjusted independently of the liquid flame spraying apparatus 108. The burner may have a wide flame so that the moving glass web stays long enough under the burner in view of heating. Preferably, the burner is to be located at a distance from the liquid flame spraying apparatus 108 that is short enough to prevent the surface of the glass from substantially cooling down as the glass proceeds from under the heating burner to reside underneath the liquid flame spraying apparatus 108. It is also possible to arrange the heating burner after the liquid flame spraying apparatus 108 with respect to the direction of movement of the glass.

Heating the glass requires that the glass product 101 should withstand a thermal shock caused by the heating. Glasses with a small thermal expansion coefficient, such as quartz glass and borosilicate glass, may be heated when the temperature of the glass is below the annealing point of the glass. In contrast, the surface of soda glass, for instance, whose thermal expansion coefficient is relatively large, may be modified by the method according to the invention only when the temperature of the glass is above the annealing point.

The viscosity of glass is strongly a function of temperature, typically following an Arrhenius type of dependency,

$$ln η = A + \frac{B}{T} \qquad ( 1 )$$

wherein A and B are constants dependent on the composition of the glass. For instance, for an ordinary soda glass, a change in temperature between 800 and 1000° C. means a decrease in viscosity in the order of two (e.g. Ceramics—Silikáty, vol. 50, Number 2, 2006, Hrma, P., “High-Temperature Viscosity of Commercial Glasses”, p. 57 to 66). Since the movement of the fine particles 109 in the layer 104 substantially depends on the viscosity of the glass, a temperature gradient enables the fine particles 109 to be distributed on the surface of the glass such that the concentration is higher in the surface part of the glass than deeper in the glass, decreasing gradiently upon proceeding deeper into the glass.

From the fine particles 109, the material 110 is diffused and dissolved in the glass surrounding the particles. However, the maximum amount of the material 110 that can become dissolved is determined by the solubility limit of the liquid 104 for the material 109. In addition, dissolution and diffusion are phenomena dependent on time t, and if the glass 104 solidifies before all the material 110 has been dissolved from the fine particle 109, a colloidal particle remains inside the material. The method according to the invention thus also enables the surface of glass to be modified by colloidal particles.

### EXAMPLES

In the following, the invention will be described in closer detail by means of an example.

### Example 1

### Steplessly Changing Surface Layer of Glass for Changing Refractive Index of Glass

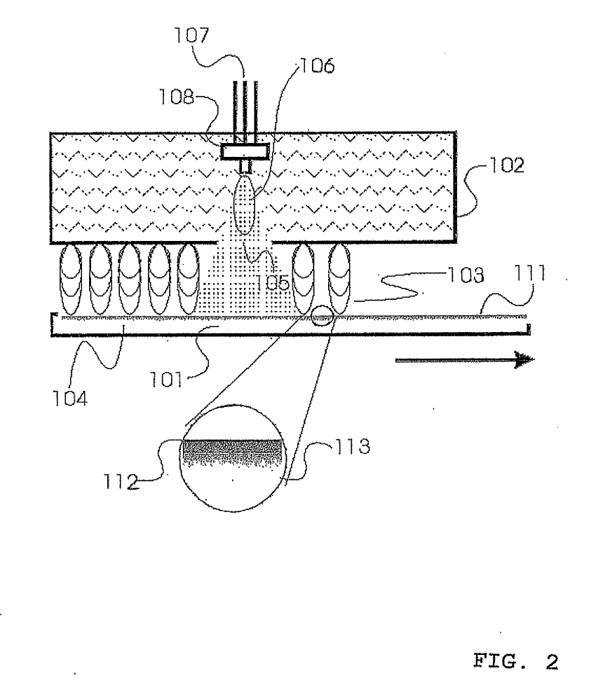

FIG. 2 shows a method according to the invention, which enables a moving glass web 101 to be provided with a steplessly, e.g. gradiently, changing refractive index surface. Such a surface may be used e.g. when producing glasses reflecting thermal radiation (low-e glasses), wherein a doped tin oxide layer provided on the surface of the glass causes the thermal radiation to be reflected from the surface of the glass. Since the refractive index of tin oxide is approximately 2, such a coating provides the surface of the glass with an interference colour caused by a refractive index difference. The interference colour may be removed when the refractive indices of the glass and the tin oxide layer are matched together by a gradiently changing layer. The principle of such a layer is set forth e.g. in U.S. Pat. No. 4,187,336 which, however, discloses no method or materials for producing such a gradiently changing refractive index layer.

By the method of modifying the surface of glass according to the invention, the surface of the moving glass web 101 whose temperature is approximately 620° C., is heated by a heater 102 which directs to the surface of the glass web 101 a flame 103 which heats the surface convectively and which may be located on one side or on both sides with respect to the direction of propagation of the process of the particle-producing liquid flame spraying apparatus 108. The heating enables the glass web 101 to be provided with a thermal gradient ΔT, wherein the temperature of the surface of the glass is approximately 800° C. On account of the thermal gradient, the surface of the glass web 101 to be coated is provided with a layer 104 wherein the the 10-base logarithm of the dynamic viscosity of the glass (P) changes from a value of approximately 9 (in the central part of the glass) to a value of approximately 5 (on the surface of the glass). Fine particles 105 whose diameter is approximately 50 nm are conveyed to the surface of the glass web 101. The material of the particles is SrO(30 mol-%)-TiO₂(45 mol-%)-SiO₂(25 mol-%), and they are produced by a method described in patent FI98832 by feeding to the liquid flame spraying apparatus 108 strontium nitrate Sr(NO₃)₂ dissolved in water as well as tetraethylorthosilane (TEOS) and tetraethylorthotitanate (TEOT) dissolved in isopropyl alcohol in proportions that provide the fine particles 105 produced in the flame 106 with the aforementioned oxide composition. The fine particles 105 penetrate into the layer 104, which has a changing viscosity, of the glass web 101 to be coated and form a layer which steplessly changes the composition of the glass material 101. From the fine particles 109 of the particular layer, the material 110 dissolves and diffuses in the layer 104. Upon cooling down, the layer 104 solidifies, whereby the surface of the object is provided with a layer which steplessly modifies the refractive index of the surface. The refractive index of an outer edge of such a coating is nearly equal to the refractive index of the produced fine particles (n_{d}=2.0) and the refractive index of an inner edge of the coating equals the refractive index of the uncoated glass web 101. The distance over which the gradient change of the refractive index takes place is approximately 4 micrometres.

### Example 2

### Steplessly Changing Surface Layer of Glass for Improving Scratch Resistance of Glass

The surface modifying method described in FIG. 2 may also be used when providing the surface of glass with a coating which improves the scratch resistance of the glass. The scratch resistance of the glass may be improved either by providing the surface of the glass with a layer consisting substantially solely of quartz glass (SiO₂) or by subjecting the surface of the glass to compression stress by providing its surface with a layer consisting substantially of titanium dioxide (TiO₂). Both layers may be provided by the diffusion coating method according to the invention. The example describes producing an SiO₂ surface, but a TiO₂ surface may be produced by the method described in the example by replacing TEOS by TEOT as a liquid starting material.

By the method of modifying the surface of glass according to the invention, the surface of a moving glass web 101, whose temperature is approximately 620° C., is heated by a heater 102 which directs to the surface of the glass web 101 a flame 103 which heats the surface convectively and which may be located one side or on both sides with respect to the direction of propagation of the process of the particle-producing liquid flame spraying apparatus 108. Consequently, the material 101 to be coated is provided with a thermal gradient ΔT, wherein the temperature of the surface of the glass is approximately 900° C. On account of the thermal gradient, the surface of the glass web 101 to be coated is provided with a layer 104 wherein the the 10-base logarithm of the dynamic viscosity of the glass (P) changes from a value of approximately 9 (in the central part of the glass) to a value of approximately 5 (on the surface of the glass). Fine particles 105 whose average diameter is approximately 40 nanometres are conveyed to the surface of the glass web 101. The material of the particles is SiO₂, and they are produced by a method described in patent FI98832 by feeding to the liquid flame spraying apparatus 108 tetraethylorthosilane (TEOS) dissolved in methanol. The fine particles 105 penetrate into the layer 104, which has a gradiently changing viscosity, of the glass web 101 to be coated and form a layer which gradiently changes the composition of the glass material 101. From the fine particles 109 of the particular layer, amorphous silicon dioxide 110 dissolves and diffuses in the material 104 to be coated. Upon cooling down, the liquid layer 104 solidifies, whereby the surface of the object is SiO₂ enriched. The composition of an outer edge of such a coating is substantially quartz glass and the composition of an inner edge of the coating is substantially the same as the composition of the glass of the glass web. The distance over which the gradient change of the composition takes place is less than 10 micrometres.

### Example 3

### Steplessly Changing Surface Layer of Glass for Improving Chemical Resistance of Glass

The diffusion coating method described in FIG. 2 may also be used when providing the surface of glass with a coating which improves the chemical resistance of the glass. The chemical resistance of the glass may be improved by providing the surface of the glass with a layer doped with aluminium oxide (Al₂O₃). Typically, an increase of a couple of percentages by weight in the amount of the aluminium oxide is optimal. Instead of aluminium oxide, titanium dioxide or zirconium oxide may also be used for improving the chemical resistance (N. Bansal & R. Doremus, Handbook of Glass Properties, (1986) Academic Press, Inc., Orlando, Fla., p. 646 to 656). In the prior art, the composition of the entire glass may be changed chemically more resistant by increasing the amount of aluminium oxide in the glass but, both economically and technically, this is undesirable.

By the method of modifying the surface of glass according to the invention, the surface of a moving glass web 101, whose temperature is approximately 550° C., is heated by a heater 102 which directs to the surface of the glass web 101 a flame 103 which heats the surface convectively. Consequently, the material 101 to be coated is provided with a thermal gradient ΔT, wherein the temperature of the surface of the glass is approximately 900° C. On account of the thermal gradient, the surface of the glass web 101 to be coated is provided with a layer 104 wherein the the 10-base logarithm of the dynamic viscosity of the glass (P) changes from a value of approximately 9 (in the central part of the glass) to a value of approximately 5 (on the surface of the glass). Fine particles 105 whose average diameter is approximately 40 nanometres are conveyed to the surface of the glass web 101. The material of the particles is Al₂O₃, and they are produced by a method described in patent FI98832 by feeding to the liquid flame spraying apparatus 108 aluminium nitrate with crystal water dissolved in methanol (Al(NO₃)₃.9H₂O). The fine particles 105 penetrate into the layer 104, which has a gradiently changing viscosity, of the glass web 101 to be coated and form a layer which gradiently changes the composition of the glass material 101. From the fine particles 109 of the particular layer, amorphous silicon dioxide 110 dissolves and diffuses in the material 104 to be coated. Upon cooling down, the liquid layer 104 solidifies, whereby the surface of the object becomes an Al₂O₃ enriched soda glass.

In addition to the aforementioned, the method may be used for providing a surface layer of glass with a layer improving the strength of the surface of the glass or for providing the surface layer of glass with a layer improving the chemical resistance of the surface of the glass. The method may further be used for modifying a surface layer of a moving, hot strip of glass or for modifying a surface layer of a hot glass package or another glass product. Consequently, a glass product may be produced wherein the content of at least one additional material introduced thereto decreases steplessly upon proceeding from the surface of the glass deeper into the glass. This enables a glass product to be achieved wherein the aluminium content and/or the silicon content and/or the strontium content and/or the titanium content and/or the content of another metal decreases steplessly upon proceeding from the surface of the glass deeper into the glass. Alternatively, the content of glass-colouring metal decreases steplessly upon proceeding from the surface of the glass deeper into the glass. This decrease in the content of additional material takes place over a distance of less than 100 micrometres upon proceeding from the surface of the glass deeper into the glass, or the decrease in the content of additional material takes place over a distance of less than 10 micrometres upon proceeding from the surface of the glass deeper into the glass, or the decrease of the content of additional material takes placer over a distance of less than 2 micrometres upon proceeding from the surface of the glass deeper into the glass.

The method according to the invention may be implemented e.g. by an apparatus comprising liquid flame spraying means (108) for forming a spraying flame (106) and means for conveying a sprayable material into the spraying flame (106), whereby the flame enables the sprayable material to be sprayed to the surface of the glass, the sprayable material forming in the flame (106) particles (105) having a diameter of less than 1 micrometre. Furthermore, the apparatus is provided such that it enables the glass to be heated such that the dynamic viscosity of the glass changes as a function of the depth of the glass, the dynamic viscosity of the glass being at its lowest on the surface of the glass, whereby diffusion and dissolution of the material contained in the particles into the glass decrease steplessly upon proceeding from the surface of the glass deeper into the glass. This may be implemented such that the spraying flame (106) is arranged such that a surface layer of the glass (101) may be heated by the spraying flame (106) simultaneously with spraying the sprayable material to the surface of the glass (101). Alternatively, the apparatus further comprises means for forming at least one other flame (103) such that the surface layer of the glass (101) may be heated by at least one other flame. The heating may also be carried out by means of both the spraying flame and at least one other flame.

It is apparent to those skilled in the art that the method according to the invention may also be used for providing a surface layer of a glass product with functionalities other than those described above. Hence, it is possible e.g. to convey particles containing a glass-colouring metal, such as cobalt, copper, iron, manganese, vanadium, chrome, silver, gold, or particles containing rare earth metals to the surface of glass. It is also possible to convey, along with the particles, a material which lowers the viscosity of glass and, consequently, further enhance the viscosity gradient produced by the method according to the invention. Such materials include alkali metals, such as lithium, sodium, and potassium.

The drawings and the related descriptions are only intended to illustrate the idea of the invention. The details of the invention may vary within the scope of the claims.

1-21. (canceled)

22. A method of modifying a surface layer of glass/a glass product, comprising conveying particles having a diameter of less than 1 micrometre to a surface of the glass, a material contained in the particles being at least partly dissolved and diffused in the glass, wherein the method comprises heating the glass such that the dynamic viscosity of the glass changes as a function of the depth of the glass, the dynamic viscosity of the glass being at its lowest on the surface of the glass, whereby the diffusion and dissolution of the material contained in the particles into the glass decrease steplessly upon proceeding from the surface of the glass deeper into the glass.

23. A method as claimed in claim 22, wherein the heating of the surface layer of the glass being carried out by a thermal power to be produced by means of a gas burner.

24. A method as claimed in claim 22, wherein the temperature of the glass being above the annealing point of the glass prior to modifying the surface layer of the glass.

25. A method as claimed in claim 22, wherein the particles containing a material which lowers the dynamic viscosity of the glass.

26. A method as claimed in claim 22, wherein a maximum value of number distribution of the diameter of the particles being provided by particles of a size of less than 300 nm.

27. A method as claimed in claim 22, wherein the particles being multicomponent particles.

28. A method as claimed in claim 22, wherein a gradiently changing refractive coefficient is provided on the surface layer of the glass.

29. A method as claimed in claim 22, wherein a layer which improves the strength of the surface of the glass is provided on the surface layer of the glass.

30. A method as claimed in claim 22, wherein a layer which improves the chemical resistance of the surface of the glass is provided on the surface layer of the glass with.

31. A method as claimed in claim 22, wherein the particles comprising at least one of the following materials: aluminium, silicon, strontium, and titanium.

32. A method as claimed in claim 22, wherein the method modifies a surface layer of a moving, hot strip of glass.

33. A method as claimed in claim 22, wherein the method modifies a surface layer of a hot glass package or another glass product.

34. A glass product modified by the method according to claim 22, wherein a surface layer of the glass product is provided with a functionality by means of at least one additional material, wherein the content of at least one additional material in the glass decreases steplessly upon proceeding from a surface of the glass deeper into the glass.

35. A glass product as claimed in claim 34, wherein the aluminium content and/or silicon content and/or strontium content and/or titanium content and/or content of another metal decreases steplessly upon proceeding from the surface of the glass deeper into the glass.

36. A glass product as claimed in claim 34, wherein the content of glass-colouring metal decreases steplessly upon proceeding from the surface of the glass deeper into the glass.

37. A glass product as claimed in claim 34, wherein the decrease in the content of additional material takes place over a distance of less than 100 micrometres upon proceeding from the surface of the glass deeper into the glass.

38. A glass product as claimed in claim 34, wherein the decrease in the content of additional material takes place over a distance of less than 10 micrometres upon proceeding from the surface of the glass deeper into the glass.

39. A glass product as claimed in claim 34, wherein the decrease in the content of additional material takes place over a distance of less than 2 micrometres upon proceeding from the surface of the glass deeper into the glass.

40. An apparatus for modifying a surface layer of glass/a glass product, the apparatus comprising liquid flame spraying means for forming a spraying flame and means for conveying a sprayable material into the spraying flame, whereby the flame enables the sprayable material to be sprayed to a surface of the glass, the sprayable material forming in the flame particles having a diameter of less than 1 micrometre, wherein the apparatus is arranged to heat the glass such that the dynamic viscosity of the glass changes as a function of the depth of the glass, the dynamic viscosity of the glass being at its lowest on the surface of the glass, whereby diffusion and dissolution of the material contained in the particles into the glass decrease steplessly upon proceeding from the surface of the glass deeper into the glass.

41. An apparatus as claimed in claim 40, wherein the spraying flame is arranged such that the surface layer of the glass is heatable by the spraying flame simultaneously with spraying the sprayable material to the surface of the glass.

42. An apparatus as claimed in claim 40, wherein the apparatus further comprises means for producing at least one other flame such that the surface layer of the glass is heatable by means of at least one other flame.
